(19) United States
(12) Patent Application Publication
(10) Pub. No.: US 2018/0126272 A1
(43) Pub. Date: May 10, 2018

(54) VIRTUAL-REALITY PROVIDING SYSTEM, VIRTUAL-REALITY PROVIDING METHOD, VIRTUAL-REALITY-PROVISION SUPPORTING APPARATUS, VIRTUAL-REALITY PROVIDING APPARATUS, AND NON-TRANSITORY COMPUTER-READABLE RECORDING MEDIUM

(71) Applicant: YAHOO JAPAN CORPORATION, Tokyo (JP)

(72) Inventor: Kenji HIRUTA, Tokyo (JP)

(73) Assignee: YAHOO JAPAN CORPORATION, Tokyo (JP)

(21) Appl. No.: 15/699,106

(22) Filed: Sep. 8, 2017

(30) Foreign Application Priority Data
Nov. 7, 2016 (JP) 2016-217031

(51) Int. Cl. A63F 13/52; G06T 19/00; G06F 17/30; G06F 3/01

(52) U.S. Cl. CPC A63F 13/52; G06T 19/006; H04L 29/04; G06F 3/017; A63F 2300/8082; G06F 17/30873

(57) ABSTRACT

A virtual-reality providing system disclosed herein includes a terminal apparatus and a server apparatus. The terminal apparatus generates a first content based on an instruction that is based on a user operation, the first content being obtained by rendering one or more objects belonging to a first category among a plurality of objects. The server apparatus generates a second content based on the instruction received from the terminal apparatus to transmit the generated second content to the terminal apparatus, the second content being obtained by rendering one or more objects belonging to a second category among the plurality of objects, wherein the terminal apparatus synthesizes the first and second contents to generate a third content.

### CROSS-REFERENCE TO RELATED APPLICATION(S)

The present application claims priority to and incorporates by reference the entire contents of Japanese Patent Application No. 2016-217031 filed in Japan on Nov. 7, 2016.

### BACKGROUND OF THE INVENTION

### 1. Field of the Invention

The embodiment discussed herein is related to a virtual-reality providing system, a virtual-reality providing method, a virtual-reality-provision supporting apparatus, a virtual-reality providing apparatus, and a non-transitory computer-readable recording medium.

### 2. Description of the Related Art

Conventionally, there is known a game system that includes (i) a terminal apparatus for receiving a user operation and (ii) a server apparatus for providing data for causing the terminal apparatus to display an image when the terminal apparatus receives the user operation (for example, see W/O 2014/065339). With regard to this, there is known a technology that (i) performs, in the terminal apparatus, rendering on a first web page for a game in response to a start of the game in response to a user operation, (ii) determines a function to be provided in the game, which has a high possibility of being used by the user, (iii) acquires a second web page for the game, which is for providing the determined function while the first web page for the game is being displayed, (iv) stores the acquired second web page for the game in a cash, and (v) performs, in the terminal apparatus, rendering on the second web page for the game stored in the cash in accordance with a user instruction for using the determined function.

However, in the above game system, there exists a problem that a processing load in the terminal apparatus to be allocated to the rendering of images is high because the rendering of images is performed only by the terminal apparatus. The above game system has a possibility that a delay term from a selection of a function to a completion of the rendering of images becomes long when a function different from the determined function is selected. Moreover, there further exists a possibility that a delay term from a user input to a completion of the rendering of images becomes longer in a case of providing a virtual reality while rendering three-dimensional images.

### SUMMARY OF THE INVENTION

It is an object of the present invention to at least partially solve the problems in the conventional technology.

A virtual-reality providing system according to the present application includes a terminal apparatus that generates a first content based on an instruction that is based on a user operation, the first content being obtained by rendering one or more objects belonging to a first category among a plurality of objects, and a server apparatus that generates a second content based on the instruction received from the terminal apparatus to transmit the generated second content to the terminal apparatus, the second content being obtained by rendering one or more objects belonging to a second category among the plurality of objects, wherein the terminal apparatus synthesizes the first and second contents to generate a third content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration of a game system 1 according to an embodiment;

FIG. 2 is a diagram schematically illustrating division of roles in the game system 1 according to the embodiment;

FIG. 3 is a diagram illustrating one example of a content 300 to be presented by a terminal apparatus 100;

FIG. 4 is a diagram explaining dispersion processes in the game system 1;

FIG. 5 is a block diagram illustrating one example of functional configurations of the terminal apparatus 100 and a game server device 200;

FIG. 6 is a flowchart illustrating a procedure for the dispersion processes in the game system 1; and

FIG. 7 is a diagram illustrating one example of hardware configurations of the terminal apparatus 100 and the game server device 200.

### DETAILED DESCRIPTION OF THE PREFERRED EMBODIMENT

Hereinafter, an embodiment of a virtual-reality providing system, a virtual-reality providing method, a virtual-reality-provision supporting apparatus, a virtual-reality providing apparatus, and a non-transitory computer-readable recording medium according to the present disclosure will be described in detail with reference to the accompanying drawings.

### Outline of Embodiment

A game system according to the embodiment is for providing a cloud game service, for example. The cloud game service is a service for transmitting, when receiving a user operation from a terminal apparatus, an instruction based on the user operation for a game server device through a network, and for transmitting a game content, such as an image, to the terminal apparatus from the game server device through the network, so as to provide the game content, such as an image, to the terminal apparatus. The game system according to the embodiment generates, by using the terminal apparatus, first image data as a first content obtained by rendering an object belonging to a first category among a plurality of objects appearing in the game. On the other hand, the game system according to the embodiment generates, by using the game server device, second image data as a second content obtained by rendering an object belonging to a second category among the plurality of objects so as to transmit the generated second image data to the terminal apparatus. The terminal apparatus synthesizes the generated first image data and the received second image data to display a game content (an example of a third content).

It is sufficient that the virtual-reality providing system according to the present disclosure provides a virtual reality for stimulating five senses of the user, and thus, for example, an image associated with a simulator service may be provided instead of the cloud game service. The simulator service provides a virtual reality of driving a vehicle, for example. Specifically, the simulator service is a service for transmitting, when receiving a steering-wheel operation of a vehicle by using the terminal apparatus, an instruction based on this steering-wheel operation to a simulator server device through the network, and for transmitting a content, such as an image, to the terminal apparatus from the simulator server device through the network, so as to provide a content associated with a simulator, such as an image, to the terminal apparatus.

Whether an object belongs to the first category or the second category is determined at any time in accordance with a rule that is previously set in the game system. For example, the previously set rule is a rule for setting an object existing within a predetermined distance from a view point in a game (virtual reality) to be an object belonging to the first category, and for setting an object existing at a position far from a certain object by more than a predetermined distance to be an object belonging to the second category. For example, when a “certain object” is a character whose position and posture are to be updated in accordance with an operation of a player, an object existing within a predetermined distance from the character is determined to be an object belonging to the first category, and an object existing at a position far from the character by more than the predetermined distance is determined to be an object belonging to the second category. Moreover, whether an object belongs to the first category or the second category may be previously set in the game system.

From another point of view, an object belonging to the first category may be an object to be rendered with a short period among a plurality of objects, and in this case, an object belonging to the second category may be an object to be rendered with a long period among the plurality of objects.

From further another point of view, an object belonging to the first category may be an object whose status is changed by an instruction based on a user operation among a plurality of objects, in this case, an object belonging to the second category may be an object whose status is not changed by the instruction among the plurality of objects.

In the following embodiment, an object belonging to the first category is assumed to be an object (hereinafter, may be referred to as “close-view object”) belonging to a close view, and an object belonging to the second category is assumed to be an object (hereinafter, may be referred to as “distant-view object”) belonging to a distant view so as to progress the explanation.

### Configuration of Game System

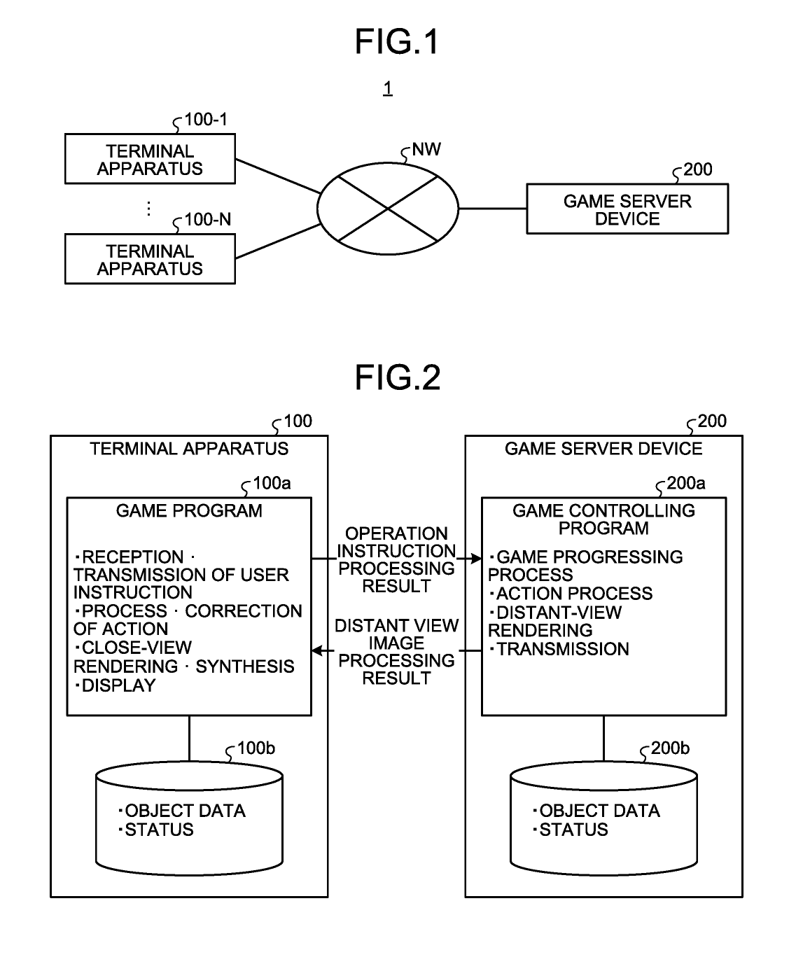

FIG. 1 is a diagram illustrating a configuration of the game system 1 according to the embodiment. FIG. 2 is a diagram schematically illustrating division of roles in the game system 1 according to the embodiment. The game system 1 provides a cloud game service in which a plurality of users joins to progress a game, for example. As illustrated in FIG. 1, the game system 1 includes a plurality of terminal apparatuses 100-1, . . . , 100-N and the game server device 200, for example. Here “N” is a natural number that is equal to or more than two. In the following explanation, when the one terminal apparatus is not distinguished from another, the plurality of terminal apparatuses 100-1, . . . , 100-N may be referred to as the “terminal apparatuses 100.”

The plurality of terminal apparatuses 100 and the game server device 200 are connected one another through a network NW. The network NW includes, for example, a wireless base station, a Wireless Fidelity (Wi-Fi) access point, a communication line, a provider, the Internet, etc. All of the combinations of these configuration elements are not needed to be communicable with one another, and a part of the network NW may include a local network.

The terminal apparatuses 100 are apparatuses to be used by users (general users). The terminal apparatuses 100 include, for example; a mobile phone such as a smartphone; a tablet terminal; and/or a computer apparatus (communication apparatus) such as a personal computer. As illustrated in FIG. 2, a game program 100a is installed in the terminal apparatus 100. For example, a Central Processing Unit (CPU) provided in the terminal apparatus 100 executes the game program 100a.

The game program 100a receives a user operation to execute an action process, a correcting process, a close-view rendering process, a synthesis process, a displaying process, etc. on the basis of an instruction corresponding to the received operation. Moreover, the game program 100a transmits, to the game server device 200, information indicating the instruction corresponding to the received operation. The action process is a process for operating a posture and a position (hereinafter, may be referred to as “status”) of an object on the basis of an instruction. The correcting process is a process for correcting a status (processing result) operated by the action process so as to obtain a status received from the game server device 200. The close-view rendering process is a process for rendering a close-view object. The synthesis process is a process for synthesizing the rendered image (hereinafter, may be referred to as “close-view rendering image”) and the image received from the game server device 200. The displaying process is a process for displaying the synthesized image (hereinafter, may be referred to as “synthesis image”). The game program 100a may execute a process for outputting a sound and a process for vibrating an operation device held by the user, in addition to the above processes.

In the game server device 200, a game controlling program 200a is installed. The game controlling program 200a is executed by the CPU provided in the game server device 200, for example. The game controlling program 200a executes a game progressing process, an action process, a distant-view rendering process, a transmitting process, etc. The game progressing process is a process for controlling the overall game. The action process is a process for operating postures and positions (statuses) of all of the objects appearing in the game. This action process operates a change in a posture and a position including effects between objects, such as a collision between the objects, in addition to a change in the posture and the position based on an instruction to each of the objects. The correcting process is a process for transmitting the status (processing result) operated by the game controlling program 200a to the terminal apparatus 100 when the status operated by the terminal apparatus 100 is different from that operated by the game controlling program 200a. The distant-view rendering process is a process for rendering a distant-view object. The transmitting process is a process for transmitting the rendered image (hereinafter, may be referred to as “distant-view rendering image”) to the terminal apparatus 100.

The terminal apparatus 100 includes a terminal-side storage 100b for storing object data and statuses. The game server device 200 includes a server-side storage 200b for storing object data and statuses. Each of the terminal-side storage 100b and the server-side storage 200b is realized by, for example, a Hard Disk Drive (HDD), a flash memory, an Electrically Erasable Programmable Read Only Memory (EEPROM), a Read Only Memory (ROM), or a Random Access Memory (RAM). Alternatively, each of the terminal-side storage 100b and the server-side storage 200b may be realized by a hybrid-type storage device including two or more of them. Each of the terminal-side storage 100b and the server-side storage 200b stores various programs such as firmware and application programs, object data, status data, processing results, etc. A part or a whole of each of the terminal-side storage 100b and the server-side storage 200b may be realized by an external storage device to be accessed through various networks. The external storage device includes a Network Attached Storage (NAS) device as one example.

The object data is data indicating static characteristics of an object, such as shape and color of the object. The status is data indicating characteristics of an object, which dynamically changes on the basis of an instruction etc., such as position and posture of the object. The object data and statuses stored in the terminal-side storage 100b and the object data and statuses stored in the server-side storage 200b are synchronized with one another during the progress of a game. In the present embodiment, any of the statuses stored in the terminal-side storage 100b are corrected by a status operated by the game server device 200.

### Category of Object

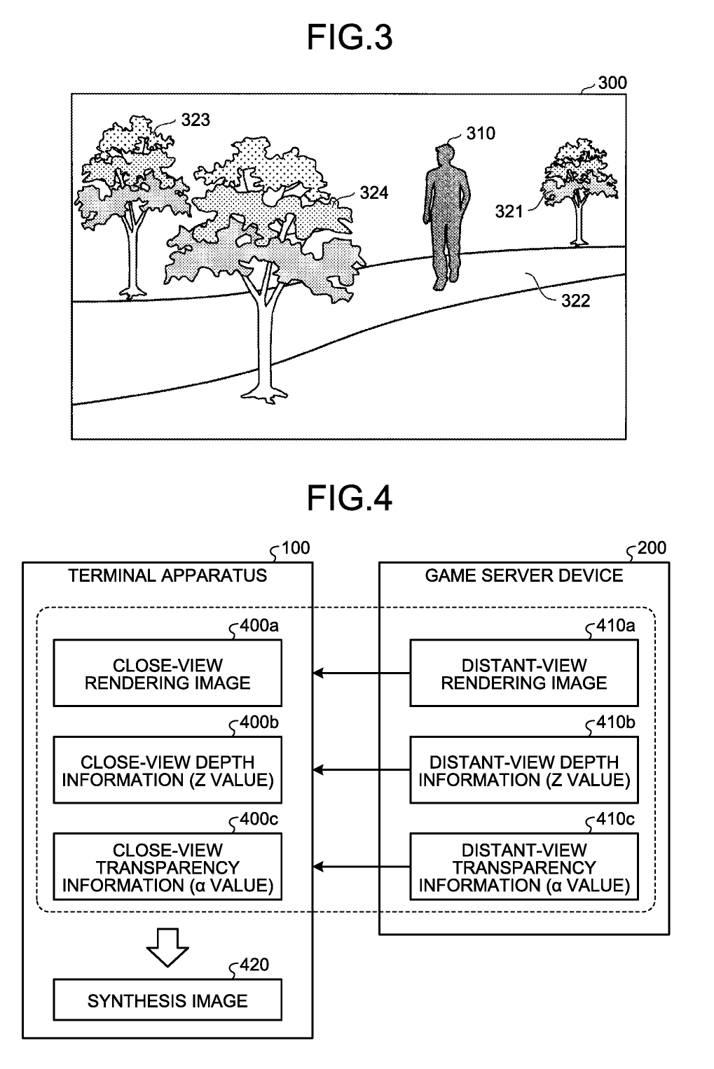

FIG. 3 is a diagram illustrating one example of the content 300 to be presented by the terminal apparatus 100. The content 300 illustrated in FIG. 3 includes a character object 310 and background objects 321, 322, 323, and 324. The character object 310 is a person, and is an object (character) whose position and posture are to be updated in accordance with an operation performed by a user (player). The background object 321 is an object that is classified into a background among a plurality of objects. The background object 321 is an object that indicates a tree positioning farther than the character object 310 referring to a predetermined view point, for example. The background object 322 is an object that indicates a road. The background objects 323 and 324 are objects that indicate trees positioning closer than the character object 310 referring to the predetermined view point. In the present embodiment, the character object 310 is one example of a close-view object, and the background objects 321 to 324 are examples of distant-view objects. The distant-view object includes a content that covers a periphery of the character object 310 in a range of 360 degrees, such as a background of the background objects 321 to 324, in addition to the background objects 321 to 324.

The character object 310 is one example of an object to be rendered in the terminal apparatus 100. The character object 310 may be replaced by an object to be rendered with a short period among a plurality of objects. The background objects 321 to 324 are examples of objects to be rendered in the game server device 200. The background objects 321 to 324 may be replaced by objects to be rendered with a long period among the plurality of objects.

The character object 310 is one example of an object whose status, such as a posture and a position, is changed in accordance with an instruction based on a user operation. The character object 310 may be replaced by an object whose status is changed in response to an instruction based on a user operation among a plurality of objects. The background objects 321 to 324 are examples of objects whose statuses, such as postures and positions, are not changed in accordance with an instruction based on a user operation. The background objects 321 to 324 may be replaced by objects whose statuses are not changed in response to an instruction among the plurality of objects.

The object belonging to the first category may be replaced by an object belonging to a character in a game, and the object belonging to the second category may be replaced by an object belonging to a background in the game.

### Dispersion Process

FIG. 4 is a diagram explaining dispersion processes in the game system 1. The terminal apparatus 100 performs, in response to reception of a user operation, a rendering process on a close-view object among objects included in the content 300 so as to generate a close-view rendering image 400a. The terminal apparatus 100 generates first synthesizing data for assisting synthesis between the close-view rendering image 400a and other image data. The first synthesizing data includes close-view depth information 400b and close-view transparency information 400c, for example. The close-view depth information 400b is information that indicates a distance from a predetermined view point of each of pixels included in the close-view rendering image 400a. The close-view depth information 400b may be also referred to as a “Z value,” for example. The close-view transparency information 400c is information that indicates a transparency degree from the predetermined view point of each of the pixels included in the close-view rendering image 400a. The close-view transparency information 400c may be also referred to as an “a value,” for example.

The game server device 200 performs a rendering process on a distant-view object among objects included in the content 300 on the basis of a user instruction received from the terminal apparatus 100 so as to generate a distant-view rendering image 410a. The game server device 200 generates second synthesizing data for assisting synthesis between the distant-view rendering image 410a and other image data. The second synthesizing data includes distant-view depth information 410b and distant-view transparency information 410c, for example. The distant-view depth information 410b is information that indicates a distance from a predetermined view point of each of pixels included in the distant-view rendering image 410a. The distant-view depth information 410b may be also referred to as a “Z value,” for example. The distant-view transparency information 410c is information that indicates a transparency degree from the predetermined view point of each of the pixels included in the distant-view rendering image 410a. The distant-view transparency information 410c may be also referred to as an “a value,” for example. The game server device 200 transmits, to the terminal apparatus 100, the distant-view rendering image 410a, the distant-view depth information 410b, and the distant-view transparency information 410c.

The terminal apparatus 100 performs the synthesis process in response to reception of the distant-view rendering image 410a, the distant-view depth information 410b, and the distant-view transparency information 410c from the game server device 200. The terminal apparatus 100 synthesizes, on the basis of the close-view depth information 400b, the close-view transparency information 400c, the distant-view depth information 410b, and the distant-view transparency information 410c, the close-view rendering image 400a and the distant-view rendering image 410a in consideration of the depth and the transparency of each of the objects referring to a predetermined view point. Thus, the terminal apparatus 100 generates a synthesis image 420 including the close-view object and the distant-view object.

The terminal apparatus 100 executes the synthesis process with a processing period of displaying the content 300, for example. The processing period is, for example, a sixtieth of a second, or may be an arbitrary period such as a thirtieth of a second. The processing period of the terminal apparatus 100 may be different form that of the game server device 200. The terminal apparatus 100 acquires information for identifying a processing period from the game server device 200 so as to synthesize the close-view rendering image 400a and the distant-view rendering image 410a that have the same processing period.

### Switch of Dispersion Process

Each of the terminal apparatus 100 and the game server device 200 determines at any time, in accordance with a previously set rule, an object to be rendered by the corresponding one of the terminal apparatus 100 and the game server device 200. Thus, each of the terminal apparatus 100 and the game server device 200 switches an object to be rendered by using the dispersion process.

### Functions of Game System

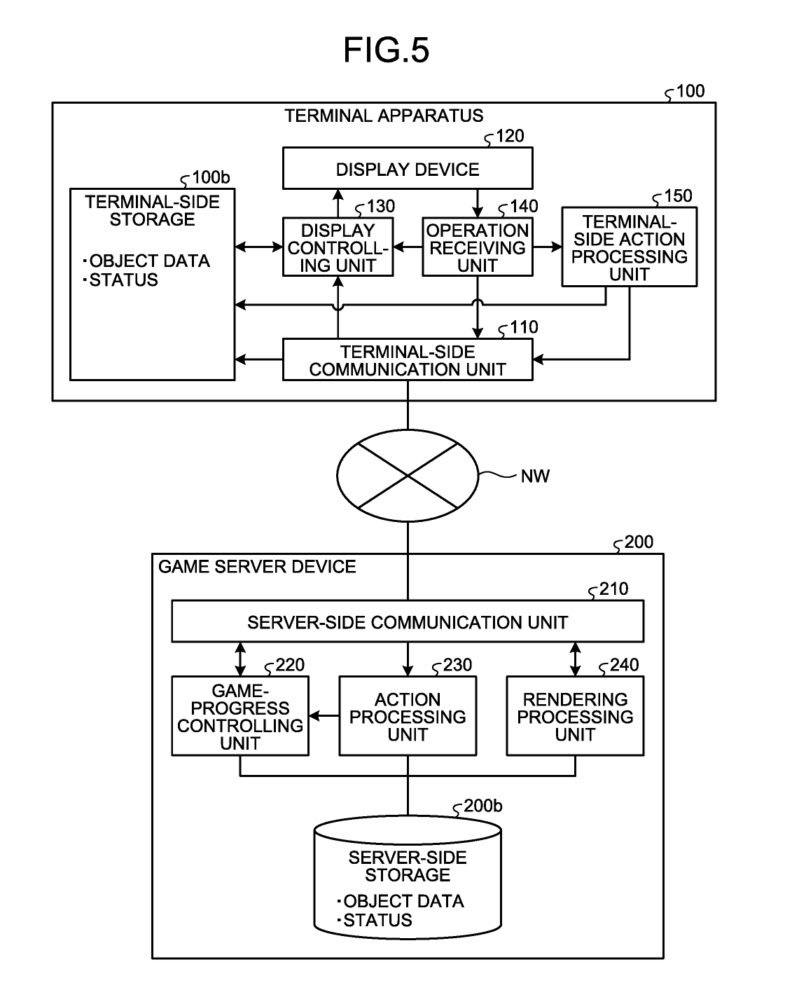

FIG. 5 is a block diagram illustrating one example of functional configurations of the terminal apparatus 100 and the game server device 200. The terminal apparatus 100 includes a terminal-side communication unit 110, a display device 120, a display controlling unit 130, an operation receiving unit 140, a terminal-side action processing unit 150, and the terminal-side storage 100b, for example.

The terminal-side communication unit 110 is a communication interface such as a Network Interface Card (NIC) and a wireless communication module. The display device 120 is a liquid crystal display including a built-in touch panel, for example. Each of the display controlling unit 130, the operation receiving unit 140, and the terminal-side action processing unit 150 is realized by execution of a program stored in a program memory by a processor such as a CPU and a Graphics Processing Unit (GPU). A part or a whole of each of these function units may be realized by hardware such as a Large Scale Integration (LSI), an Application Specific Integrated Circuit (ASIC), and a Field-Programmable Gate Array (FPGA), or may be realized by cooperation between the software and hardware.

The display controlling unit 130 executes the close-view rendering process on the basis of a user operation received by the operation receiving unit 140 and information received by the terminal-side communication unit 110. The operation receiving unit 140 receives an operation for the display device 120 to generate operation information of a user. The terminal-side action processing unit 150 executes the action process on the basis of the operation information generated by the operation receiving unit 140. The terminal-side action processing unit 150 operates a status of an object as a result of the action process so as to update a status stored in the terminal-side storage 100b. The rendering process in the display controlling unit 130 includes a process for determining at any time an object to be rendered in accordance with a previously set rule.

The game server device 200 includes a server-side communication unit 210, a game-progress controlling unit 220, an action processing unit 230, a rendering processing unit 240, and the server-side storage 200b, for example. Each of the game-progress controlling unit 220, the action processing unit 230, and the rendering processing unit 240 is realized by execution of a program stored in a program memory by a processor of a CPU, a GPU, etc., for example. A part or a whole of each of these function units may be realized by hardware such as an LSI, an ASIC, and an FPGA, or may be realized by cooperation between the software and hardware. Moreover, a part of functions of each of the game-progress controlling unit 220, the action processing unit 230, and the rendering processing unit 240 may be implemented on another server apparatus, and the game server device 200 may execute the process while cooperating with this server apparatus.

The server-side communication unit 210 is a communication interface such as an NIC and a wireless communication module. The game-progress controlling unit 220 executes the game progressing process. The action processing unit 230 executes the action process. The rendering processing unit 240 executes the distant-view rendering process. The rendering process in the rendering processing unit 240 includes a process for determining at any time an object to be rendered in accordance with a previously set rule.

### Procedure for Dispersion Processes

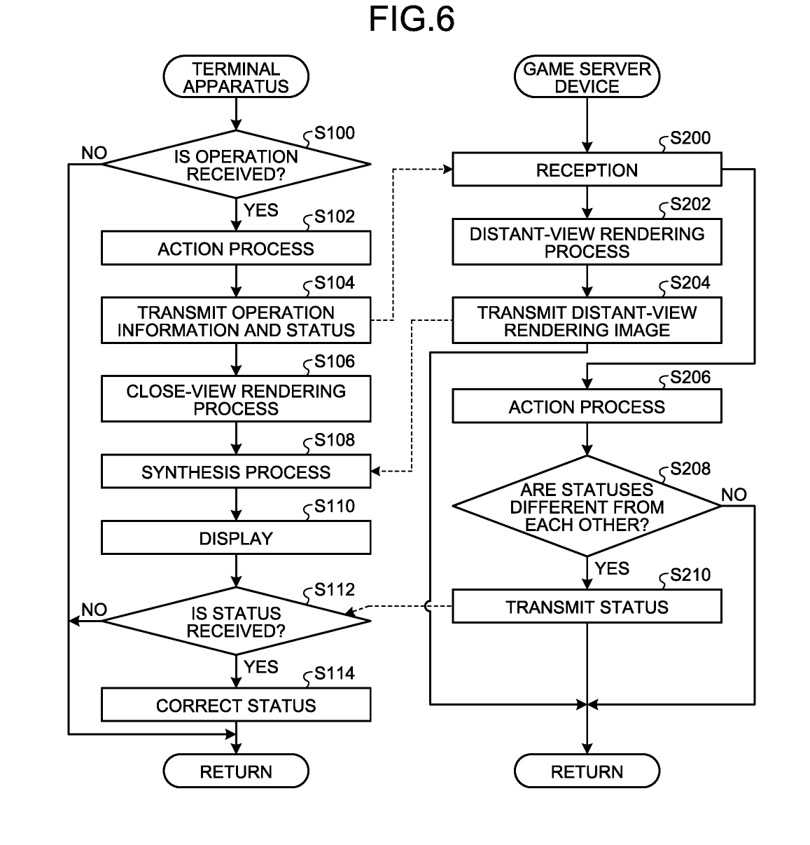

FIG. 6 is a flowchart illustrating a procedure for the dispersion processes in the game system 1. The terminal apparatus 100 and the game server device 200 execute processes to be explained hereinafter. First, the terminal apparatus 100 determines whether or not the terminal apparatus 100 receives a user operation (Step S100). When not receiving any user operation, the terminal apparatus 100 terminates the process of this flowchart. When receiving a user operation, the terminal apparatus 100 executes an action process on the basis of the received operation (Step S102). Next, the terminal apparatus 100 transmits, to the game server device 200, operation information indicating the received operation and a status as a processing result of the action process(Step S104).

The game server device 200 executes, in response to a reception of the operation information and status from the terminal apparatus 100 (Step S200), a rendering process for rendering a distant-view object (Step S202). The game server device 200 transmits a distant-view rendering image to the terminal apparatus 100 (Step S204).

The game server device 200 executes, in response to the reception of the operation information and the status from the terminal apparatus 100 (Step S200), an action process on the basis of the received operation information in parallel with the processes of Steps S202 and S204 (Step S206). The game server device 200 determines whether or not the received status and the status as the result of the executed action process are different from each other (Step S208). When the received status and the status as the result of the executed action process are not different from each other, the game server device 200 terminates the process of this flowchart. When the received status and the status as the result of the executed action process are different from each other, the game server device 200 transmits, to the terminal apparatus 100, the status as the result of the executed action process (Step S210).

For example, when a plurality of user joins a game, there exists a case where a close-view object (1) operated by a user corresponding to the terminal apparatus 100-1 and a close-view object (N) operated by a user corresponding to the terminal apparatus 100-N collide with each other in the game. In this case, the game server device 200 determines the collision between the close-view objects in the action process, and executes a predetermined action process for the collision. For example, the predetermined action process is a process for generating an event for changing positions (statuses) such that both the close-view objects are flicked from the collision position. The game server device 200 transmits, to the terminal apparatus 100-1, a status of the close-view object (1) which indicates the changed position, and transmits, to the terminal apparatus 100-N, a status of the close-view object (N) which indicates the changed position.

After Step S104, the terminal apparatus 100 executes a rendering process for rendering the close-view object (Step S106). Next, the terminal apparatus 100 executes a synthesis process for synthesizing the close-view rendering image rendered in Step S106 and the distant-view rendering image (Step S108). The terminal apparatus 100 executes the synthesis process by using the newest distant-view rendering image of distant-view rendering images received by the game server device 200. Next, the terminal apparatus 100 causes the display device 120 to display the content 300 as a result of the synthesis process (Step S110).

Next, the terminal apparatus 100 determines whether or not the terminal apparatus 100 receives the status of the close-view object from the game server device 200 (Step S112). When not receiving the status of the close-view object, the terminal apparatus 100 terminates the process of this flowchart. When receiving the status of the close-view object, the terminal apparatus 100 overwrites a status stored in the terminal-side storage 100b with the status received from the game server device 200 so as to correct the status of the close-view object (Step S114).

The above-explained game system 1 includes (i) the terminal apparatus 100 that generates a first content, which is obtained by rendering one or more objects belonging to the first category, on the basis of a user operation and (ii) the game server device 200 that generates a second content, which is obtained by rendering one or more objects belonging to the second category, on the basis of the instruction received by the terminal apparatus 100 so as to transmit the generated second content to the terminal apparatus 100, and thus the terminal apparatus 100 can synthesize the first and second contents to be able to display the synthesized content 300. By employing this game system 1, a processing load of rendering contents is dispersed, so that it is possible to suppress a delay term from a user operation to a completion of rendering of the contents.

In other words, by employing the game system 1, the terminal apparatus 100 renders one or more objects belonging to the first category, so that it is possible to shorten a delay time until a first object is presented more than a delay time in a case where the game server device 200 renders and displays the one or more objects belonging to the first category. Moreover, by employing the game system 1, the game server device 200 renders one or more objects belonging to the second category, so that it is possible to shorten a delay time until the first object is presented more than a delay time in a case where the terminal apparatus 100 renders and displays the objects belonging to the first and second categories.

This game system 1 determines an object belonging to the first category to be an object belonging to a close view and determines an object belonging to the second category to be an object belonging to a distant view, and thus the terminal apparatus 100 can render a close-view object. Thus, the game system 1 can shorten a delay time until the close-view object is presented more than a delay time in a case where the game server device 200 renders and displays the close-view object. For example, when a close-view object is determined to be a character that is moved by a user operation, the game system 1 can immediately move the character in response to a reception of the user operation.

This game system 1 determines an object belonging to the first category to be an object to be rendered with a short period and determines an object belonging to the second category to be an object to be rendered with a long period, and thus the terminal apparatus 100 can render an object to be rendered with a short period. Thus, the game system 1 can shorten a delay time until the object to be rendered with a short period is presented more than a delay time in a case where the game server device 200 renders and displays the object to be rendered with a short period. For example, when a character that is moved by a user operation is set to be an object to be rendered with a short period, the game system 1 can immediately move the character in response to a reception of the user operation.

This game system 1 determines an object belonging to the first category to be an object whose status is changed in response to an instruction and determines an object belonging to the second category to be an object whose status is not changed in response to the instruction, and thus the terminal apparatus 100 can render the object whose status is changed in response to the instruction. Thus, the game system 1 can shorten a delay time until the object whose status is changed in response to the instruction is presented more than a delay time in a case where the game server device 200 renders and displays the object whose status is changed in response to the instruction.

This game system 1 synthesizes the first and second contents by using (i) depth information and transparency information generated by the terminal apparatus 100 and (ii) depth information and transparency information generated by the game server device 200, and thus consistency between the depth and transparency can be appropriately adjusted between the first and second contents.

Moreover, the game system 1 transmits, from the terminal apparatus 100 to the game server device 200, first statuses of the one or more objects belonging to the first category, which are operated on the basis of an instruction that is based on the user operation, in addition to the instruction. The game server device 200 operates second statuses of the one or more objects belonging to the first category on the basis of the instruction received from the terminal apparatus 100. The game server device 200 transmits the operated second statuses to the terminal apparatus 100. When the second statuses operated by the game server device 200 differ from the first statuses, the terminal apparatus 100 changes first image data on the basis of the second statuses. Thus, even when the terminal apparatus 100 operates a status of a close-view object so as to render the close-view object, the game system 1 can correct the status of the close-view object rendered by effects of another close-view object etc. so as to render the close-view object again. As a result, by employing the game system 1, it is possible to correct and render a status of a close-view object while suppressing a delay time of rendering the close-view object.

The above game system 1 renders an image as a content, not limited thereto, the above game system 1 may render a sound.

### Hardware Configuration

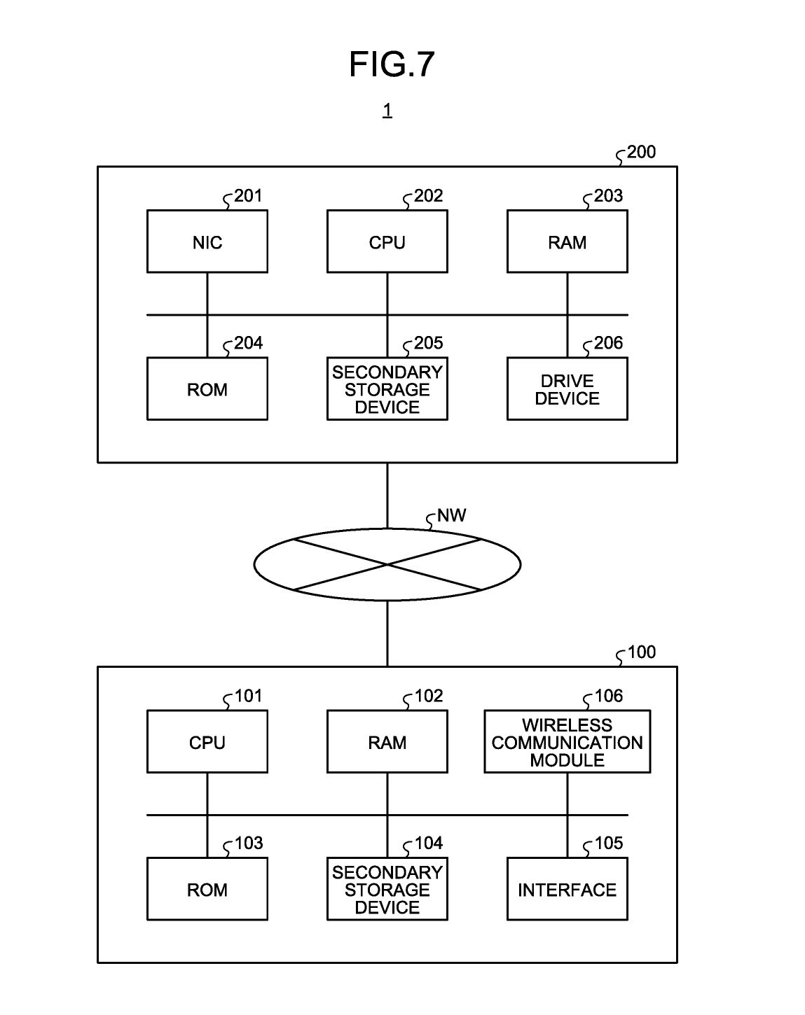

FIG. 7 is a diagram illustrating one example of hardware configurations of the terminal apparatus 100 and the game server device 200. In FIG. 7, the example is illustrated in which the terminal apparatus 100 is a personal computer etc. The terminal apparatus 100 has a configuration in which, for example; a CPU 101; a RAM 102; a ROM 103; a secondary storage device 104 such as a flash memory; an interface 105 for operation, display, etc.; and a wireless communication module 106 are connected with one another by an inner bus or a dedicated communication line.

The game server device 200 has a configuration in which, for example; an NIC 201; a CPU 202; a RAM 203; a ROM 204; a secondary storage device 205 such as a flash memory and a HDD; and a drive device 206 are connected with one another by an inner bus or a dedicated communication line. The drive device 206 is provided with a portable storage medium such as an optical disk. A program, which is stored in a portable storage medium provided in the secondary storage device 205 or the drive device 206, is expanded in the RAM 203 by a Direct Memory Access (DMA) controller etc. to be executed by the CPU 202, whereby a function unit of the game server device 200 is realized.

According to one aspect of the present disclosure, it is possible to suppress a delay term by dispersing a processing load for rendering a content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A virtual-reality providing system comprising:
a terminal apparatus that generates a first content based on an instruction that is based on a user operation, the first content being obtained by rendering one or more objects belonging to a first category among a plurality of objects; and
a server apparatus that generates a second content based on the instruction received from the terminal apparatus to transmit the generated second content to the terminal apparatus, the second content being obtained by rendering one or more objects belonging to a second category among the plurality of objects, wherein
the terminal apparatus synthesizes the first and second contents to generate a third content.

2. The virtual-reality providing system according to claim 1, wherein
the one or more objects belonging to the first category include an object belonging to a close view, and
the one or more objects belonging to the second category include an object belonging to a distant view.

3. The virtual-reality providing system according to claim 1, wherein
the one or more objects belonging to the first category include an object to be rendered with a short period among the plurality of objects, and
the one or more objects belonging to the second category include an object to be rendered with a long period among the plurality of objects.

4. The virtual-reality providing system according to claim 1, wherein
the one or more objects belonging to the first category include an object whose status is changed in response to the instruction among the plurality of objects, and
the one or more objects belonging to the second category include an object whose status is not changed in response to the instruction among the plurality of objects.

5. The virtual-reality providing system according to claim 1, wherein each of the terminal apparatus and the server apparatus determines an object to be rendered based on a previously set rule.

6. The virtual-reality providing system according to claim 1, wherein
each of the first and second contents includes an image content,
the terminal apparatus generates first synthesizing data for assisting in synthesizing the first content and another content,
the server apparatus generates second synthesizing data for assisting in synthesizing the first and second contents to transmit the generated second synthesizing data to the terminal apparatus, and
the terminal apparatus synthesizes the first and second contents based on the first and second synthesizing data.

7. The virtual-reality providing system according to claim 6, wherein
the first synthesizing data includes information that indicates a distance and a transparency degree, from a predetermined view point, of each pixel included in the first content, and
the second synthesizing data includes information that indicates a distance and a transparency degree, from the predetermined view point, of each pixel included in the second content.

8. The virtual-reality providing system according to claim 1, wherein
the terminal apparatus transmits, to the server apparatus, first statuses of the one or more objects belonging to the first category in addition to the instruction, the first statuses being operated based on the instruction,
the server apparatus operates second statuses of the one or more objects belonging to the first category based on the instruction received from the terminal apparatus so as to transmit the operated second statuses to the terminal apparatus, and
the terminal apparatus changes, when the second statuses operated by the server apparatus differ from the first statuses, the first content based on the second statuses.

9. A virtual-reality providing method comprising:
receiving, by a terminal apparatus, an instruction based on a user operation;
transmitting, by the terminal apparatus, the instruction to a server apparatus;
generating, by the terminal apparatus, a first content to present a third content based on the generated first content, the first content being obtained by rendering one or more objects belonging to a first category among a plurality of objects;
generating, by the server apparatus, a second content based on the instruction received from the terminal apparatus to transmit the generated second content to the terminal apparatus, the second content being obtained by rendering one or more objects belonging to a second category among the plurality of objects; and
synthesizing, by the terminal apparatus, the first and second contents to generate a third content.

10. A virtual-reality-provision supporting apparatus comprising:
a reception unit that receives, from a terminal apparatus, (i) an instruction based on a user operation and (ii) a first content obtained by rendering, based on the instruction, one or more objects belonging to a first category among a plurality of objects;
a generation unit that generates, based on the instruction received from the terminal apparatus, a second content obtained by rendering one or more objects belonging to a second category among the plurality of objects; and
a transmitting unit that transmits the second content generated by the generation unit to the terminal apparatus.

11. A non-transitory computer-readable recording medium having stored therein a program that causes a computer to execute a process comprising:
receiving, from a terminal apparatus, (i) an instruction based on a user operation and (ii) a first content obtained by rendering, based on the instruction, one or more objects belonging to a first category among a plurality of objects;
generating, based on the instruction received from the terminal apparatus, a second content obtained by rendering one or more objects belonging to a second category among the plurality of objects; and
transmitting the generated second content to the terminal apparatus.

12. A virtual-reality providing apparatus comprising:
a reception unit that receives an instruction based on a user operation;
a generation unit that generates, based on the instruction received from the reception unit, a first content obtained by rendering one or more objects belonging to a first category among a plurality of objects;
a reception unit that receives, from a server apparatus, a second content obtained by rendering, based on the instruction, one or more objects belonging to a second category among the plurality of objects; and
a synthesis unit that synthesizes the first content generated by the generation unit and the second content received by the reception unit to generate a third content.

13. A non-transitory computer-readable recording medium having stored therein a program that causes a computer to execute a process comprising:
receiving an instruction based on a user operation;
generating, based on the received instruction, a first content obtained by rendering one or more objects belonging to a first category among a plurality of objects;
receiving, from a server apparatus, a second content obtained by rendering, based on the instruction, one or more objects belonging to a second category among the plurality of objects; and
synthesizing the generated first content and the received second content to generate a third content.
